(19) United States
(12) Patent Application Publication
(10) Pub. No.: US 2018/0057306 A1
(43) Pub. Date: Mar. 1, 2018

(54) Retractable Cabling Device for reaching/Pick-up Tool for Medical Appliance Applications

(71) Applicant: JOSEPH ANTHONY BELLINO, CEDAR PARK, TX (US)

(72) Inventor: JOSEPH ANTHONY BELLINO, CEDAR PARK, TX (US)

(21) Appl. No.: 15/230,644

(22) Filed: Aug. 29, 2016

(51) Int. Cl. B65H 75/42

(52) U.S. Cl. CPC B65H 75/42; A61H 2003/002

(57) ABSTRACT

The invention provides for the user who is unable to bend at the waist a means of retrieving their grabbing device or accessory. Typically patients who have walkers or medical appliances and are unable to bend at the waist use a grabbing device for picking items up off of the floor. When the user drops their grabbing device, they have no means for retrieving it.

The claimed invention provides a spring-loaded retractable cable/cord that can be attached to the grabbing device for easy retrieval. The spring-loaded retractable cable/cord can be integral with the accessory bag typical to that of walkers and other medical appliances or it can be retrofit into any suitable bag via adhesive and Velcro. It can also be attached to the walker or user via adhesive, Velcro, clip as well as any suitable attachment means as known by those in the art.

### CROSS REFERENCES TO RELATED APPLICATIONS

| | | Publication | | |
|---|---|---|---|---|
| Cited Patent | Filing date | date | Applicant | Title |
| U.S. Pat. No. 4,488,511 | Mar. 7, 1983 | Dec. 18, 1984 | Grassano Vincent R | Shock-absorbent leash |
| | | | | for animals |
| U.S. Pat. No. 5,423,494 | Jan. 28, 1994 | Jun. 13, 1995 | Daido Tokushuko | Pet rope winder |
| | | | Kabushiki Kaisha | |
| US20140238314* | May 2, 2014 | Aug. 28, 2014 | Carolyn O'Brien | Retractable Leash |
| US20150237832* | May 8, 2015 | Aug. 27, 2015 | Carolyn O'Brien | Retractable Leash |
| US20120073516 | Sep. 27, 2010 | Mar. 29, 2012 | Joseph Ek | Retractable leash with |
| | | | | automatic braking |
| | | | | mechanism |

Essential Medical Supply Reacher, 32½—https://www.amazon.com/Essential-Medical-Supply-Reacher-32/dp/B001CBA286

Reachers and Grabber Tools—http://www.advantagemedical.com/shop-by-department/adl-products/aids-for-daily-living/aids-for-daily-living/reachers/

Flexi Vario Retractable Cord Dog Leash, Granite—https://www.chewy.com/flexi-vario-retractable-cord-dog/dp/112938?utm_source=google-product&utm_medium=cpc&utm_campaign=hg&utm_content=Flexi&utm_term=&gclid=CLSv m7D3pc4CFZaMaQodlmcL5g

Flexi New Classic Retractable Cord Dog Leads—http://www.petsolutions.com/C/Dog-Leashes-Leads/I/Flexi-New-Classic-Retractable-Cord-Dog-Leads.aspx?CAWELAID=520009670000358920&CAGPSPN=pla&CAAGID=10933039693&CATCI=pla-73623293293&catargetid=520009670000046784&cadevice=c&gclid=CJyCrsf3pc4CFZQ0aQod VWwHHA

### FIELD OF INVENTION

The invention relates to the general field of cabling mechanics, and has certain specific application to Medical Appliances, grabbing and Pick-up Tools.

### BACKGROUND

The problem arises when a patient has hip replacement surgery and the said individual is not allowed or unable to bend at the waist. The patient is then provided with a grabbing tool or pick-up device whereas the user is able to grasp items and/or dress without bending at the waist. This is also a problem for anyone who uses a walker and is unable to bend at the waist. Currently, there is no means for the user to retrieve their grabbing tool once it has been dropped.

The claimed invention when used in conjunction with said grabbing tool or pick-up device allows the said user to never lose contact with said gripping tool or pick-up device. Should the said user drop the grabbing tool or pick-up device, the retractable cabling device allows the user to never lose contact of the said grabbing tool or pick-up device preventing the said user from having to bend over which may not be possible or allowed by their consulting physician.

### SUMMARY

The disclosed Retractable Cabling Device provides the user with a constant means of retaining the grabbing tool or pick-up device. It may be used by persons recovering from hip surgery as well as anyone who uses a walker or medical appliance whereas the user is not allowed or cannot bend at the waist.

### BRIEF DESCRIPTION OF THE DRAWINGS

Various embodiments of the invention are disclosed in the following detailed description and accompanying drawings.

FIG. 1 illustrates a side perspective view of the invention in use

FIG. 2 illustrates a front elevation view of the invention

FIG. 3 illustrates illustrates a perspective view of the invention

FIG. 4 illustrates illustrates a sectional view taken along line 4-4 in FIG. 3

FIG. 5 illustrates illustrates a sectional view illustrating an alternate embodiment whereas the retractable cord device is attached to the inside of the bag via adhesive and Velcro.

FIG. 6 illustrates illustrates a sectional view illustrating an alternate embodiment whereas the retractable cord device sitting freely at the bottom of the bag

FIG. 7 illustrates illustrates a sectional view illustrating an alternate embodiment whereas the retractable cord device is mounted to the appliance/walker

FIG. 8 illustrates illustrates an exploded perspective view of an alternate embodiment whereas the retractable cord device is adhered to the outside of the bag via adhesive and Velcro.

FIG. 9 illustrates illustrates an exploded perspective view of an alternate embodiment whereas the retractable cord device is adhered to the outside of the appliance via adhesive and Velcro.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The Bag with Removable Retractable Cord for Walkers and other Medical Appliances is comprised of a bag 16 that contains an integral spring-loaded, retractable cable 10 which is contained in the bag 16 via the optional cord device pouch 28.

The spring-loaded retractable cord device is comprised of a coil spring 32, a retractable cable/cord 12, an optional locking mechanism 26 and a clasping device 14.

The clasping device 14 shall be clipped to the grabbing device/accessory 20 via the connector ring 34.

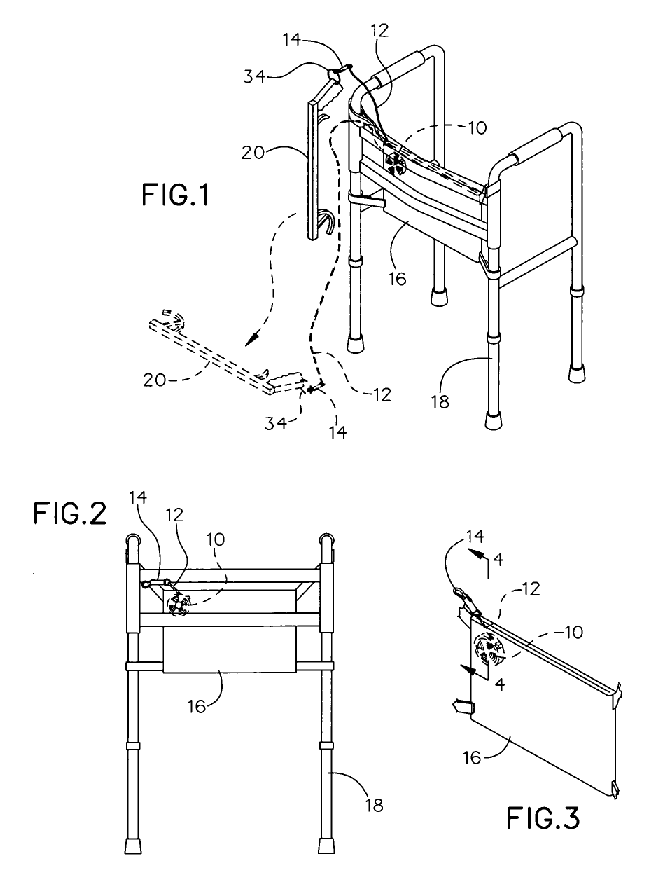

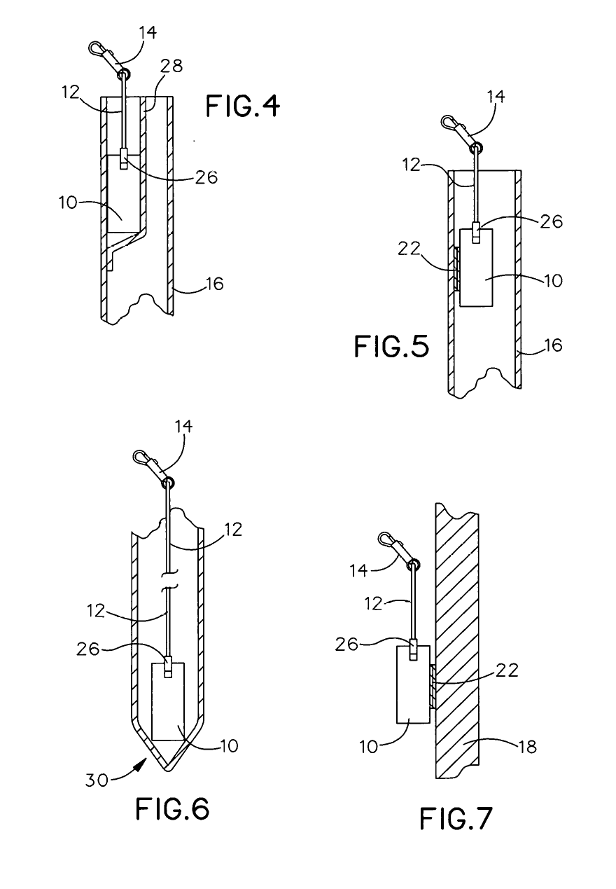

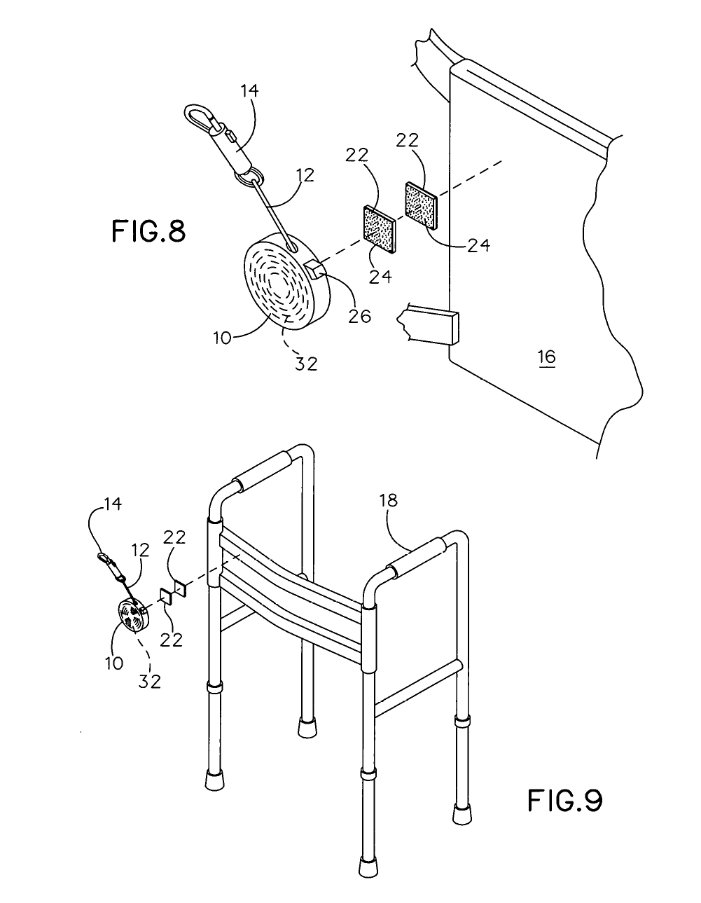

As seen in FIG. 1, should the user drop the grabbing device/accessory 20, the user would simply grab the cable/cord 12 and retrieve the grabbing device/accessory 20 and return it to its normal operative position. Furthermore, should the user decide not to use the optional locking mechanism 26, the natural spring tension on the cable/cord 12 would prevent the grabbing device/accessory 20 from falling to the ground.

Alternatively as illustrated in FIG. 6, the spring loaded retractable cord device 10 may be dropped into the bag 16 without the use of the pouch 28.

Another embodiment allows for the spring-loaded retractable cord device 10 to be mounted to the inside of any bag via adhesive 24 and Velcro 22 as illustrated in FIG. 5.

A third embodiment allows for the spring-loaded retractable cord device 10 to be mounted to the walker/medical appliance 18 via the adhesive 24 and Velcro 22.

### CONCLUSION

The disclosed embodiments are illustrative, not restrictive. While specific configurations of the Retractable Cabling Device have been described, it is understood that the present invention can be applied to a wide variety of medical appliances as well as said user. There are many alternative ways of implementing the invention.

What is claimed is:

1. A Retractable Cabling Device used in conjunction with a medical bag, specifically:
2. 1. a medical appliance bag with integral retractable cabling device;

3. A Retractable Cabling Device used in conjunction with a walker bag, walker, medical 4. appliance or said user; specifically:
1. a medical appliance bag with integral retractable cabling device;
2. a retractable cabling device used without the medical bag and integral with the medical appliance, and
3. a retractable cabling device attached thereto and used by the said user.

3. A Retractable Cabling Device adhered to a medical appliance, specifically a walker with the ability to be attached to the medical appliance via the medical bag or without the medical bag utilizing a clip-on, Velcro or adhesive attachment means.
